(19) United States
(12) Patent Application Publication
(10) Pub. No.: US 2013/0300666 A1
(43) Pub. Date: Nov. 14, 2013

(54) VOICE KEYBOARD

(71) Applicants: Donald Gene Archer, Euless, TX (US); Andrien John Wang, Keller, TX (US)

(72) Inventors: Donald Gene Archer, Euless, TX (US); Andrien John Wang, Keller, TX (US)

(73) Assignee: Verizon Patent and Licensing Inc., Basking Ridge, NJ (US)

(21) Appl. No.: 13/469,796

(22) Filed: May 11, 2012

(51) Int. Cl. G06F 3/02; G10L 15/26

(52) U.S. Cl. 345/168

(57) ABSTRACT

A method may include receiving a keyed input from a user in a user device, wherein the keyed input indicates a letter of a word. The method may also include receiving an audio input from the user in the user device, wherein the audio input indicates the word. The method may also include generating a first list of predicted words based on the audio input and the keyed input from the user and displaying the first list of predicted words to the user.

### BACKGROUND

User devices, particularly mobile devices such as mobile phones and tablet computers, typically have a keyboard (e.g., on the screen or a physical keyboard) on which the user types. As the user types, the typed letters are echoed onto the screen. The user device may predict what word the user is typing and display a list of those words on the screen. Some devices allow for voice recognition. For these devices, when the user speaks, words are recognized, and the words (e.g., the words likely to correspond to the spoken word) are displayed on the screen.

### BRIEF DESCRIPTION OF THE DRAWINGS

FIG. 1 illustrates a user device that may be used in one embodiment;

FIG. 2 illustrates an environment including the user device of FIG. 1 that may be used according to one embodiment;

FIG. 3 is a block diagram of exemplary components of a computing module, according to one embodiment, that may be included in the devices shown in FIG. 2;

FIG. 4A is a bock diagram of the functional components of the voice-to-text server of FIG. 2;

FIG. 4B is a block diagram of the functional components of text prediction server of FIG. 2;

FIG. 4C is a block diagram of the functional components of the user device of FIG. 1;

FIG. 5 is a flowchart for a process implementing a voice keyboard in one embodiment;

FIGS. 6A and 6B illustrate messages passed between the user device, the voice-to-text server, and the text prediction server of the environment of FIG. 2; and

FIGS. 7A and 7B illustrate the user device of FIG. 1 in one embodiment.

### DETAILED DESCRIPTION OF THE PREFERRED EMBODIMENTS

The following detailed description refers to the accompanying drawings. The same reference numbers in different drawings may identify the same or similar elements. The following detailed description does not limit the invention, as claimed.

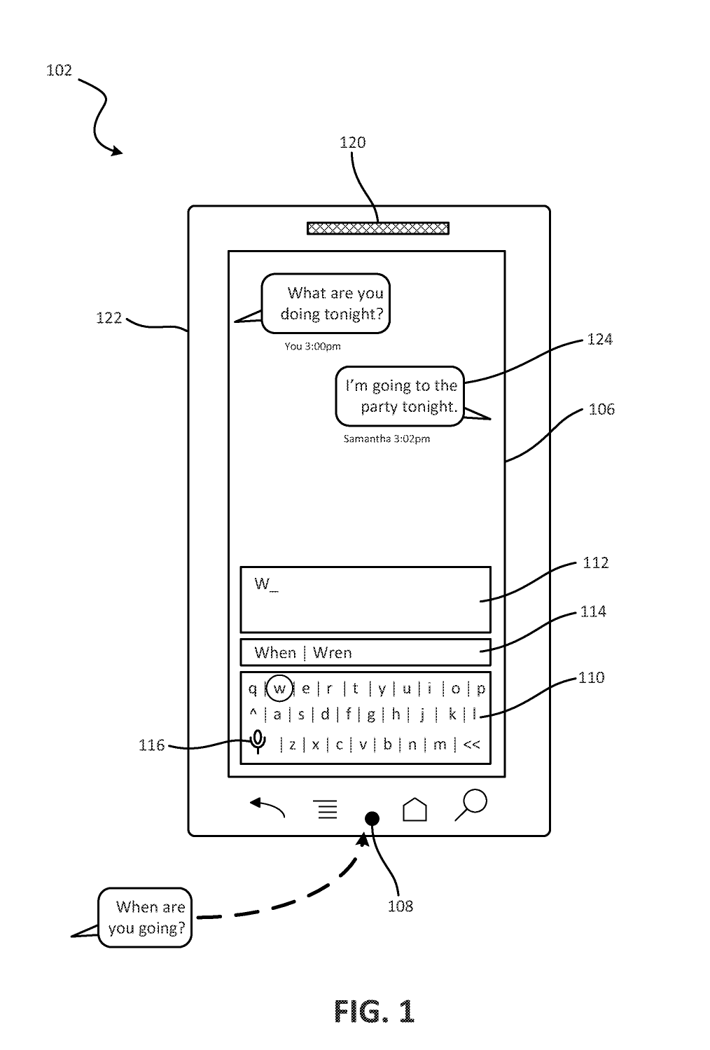

As discussed above, a user device may predict the word the user is typing based on the keys the user has pressed on the keyboard. Also, a user device may predict the word the user has spoken in lieu of typing. Methods describe below allow the user device to predict the word a user is typing based on both the keys the user has pressed and the word spoken by the user. For example, FIG. 1 illustrates a user device 102 that may be used in one embodiment. As shown in FIG. 1, the user has typed the letter “w” on a display 106 of a user device 102, and the “w” has been echoed to field 112 of display 106. In this example, the user may also say “when” into a microphone 108 of device 102. In one embodiment, the user device generates a first list of predicted words based on the keys pressed (e.g., “w”) and a second list of predicted words based on the spoken word (e.g., “when”). In this embodiment, the user device may then generate a third list of predicted words based on the first list (based on the keys pressed) and the second list (based on the spoken word), and display this third list of words on display 106 as predicted word list 114.

Device 102 may include any computational device, including among other things: a tablet computer, a mobile phone, a personal computer, a fixed-line phone, a personal music player (PMP), a mobile device, and/or a personal digital assistant (PDA). User device 102 may include display 106, a microphone 108, a keyboard 110, an echo field 112, a predicted word list 114, an icon 116, a speaker 120, and a housing 122. Housing 122 may provide a protective shell for the other components of device 102 and may house these components.

Display 106 may provide visual information to the user, such as a received text message, a menu, a keyboard, video images, pictures, etc. Display 106 may include a touch-sensitive surface such that display 106 may be an input device as well as an output device. Microphone 108 receives sound, such as the user's voice during a telephone call. Microphone 108 may also receive the user's voice for converting the voice to text as a method of input (e.g., when the user is using keyboard 110 for typing or instead of the user using keyboard 110 for typing).

Keyboard 110 may include an alphanumeric, a numeric, and/or a telephone keypad. Although keyboard 110 is shown as a “soft” keyboard (e.g., a keyboard displayed on display 106, which is touch sensitive), in other implementations, keyboard 110 may be a physical keyboard with physical keys.

Display 106 may include an echo field 112. Echo field 112 displays or echoes the keys pressed on keyboard 110, for example. Echo field 112 may also echo a word selected from predicted word list 114. Predicted word list 114 displays a list of words that device 102 predicts that the user is typing or speaking For example, as shown in FIG. 1, if the user presses the “w” key (and possibly after saying “when”), device 102 may predict that the user is in the process of typing the word “when” or “wren.”

In one embodiment, icon 116 indicates to the user that device 102 is in “voice keyboard” mode. That is, device 102 may be using both the keyed input and the audio input (e.g., voice or speech input) to determine list 114 of predicted words. Speaker 120 provides audible information to the user of device 102. For example, speaker 120 may output the voice of a person with whom the user of device 102 is having a conversation.

User device 102 may allow the user to initiate or receive telephone calls, send or receive messages to or from other user devices, etc. As such, user device 102 may communicate with other devices via base transceiver stations (BTSs, not shown) using a wireless communication protocols, e.g., GSM (Global System for Mobile Communications), CDMA (Code-Division Multiple Access), WCDMA (Wideband CDMA), GPRS (General Packet Radio Service), EDGE (Enhanced Data Rates for GSM Evolution), etc. In one embodiment, user device 202 may communicate with other devices using wireless network standards such as WiFi (e.g., IEEE 802.11x) or WiMAX (e.g., IEEE 802.16x). In yet another embodiment, user device 202 may communicate with other devices via a wired network using, for example, a public-switched telephone network (PSTN) or an Ethernet network.

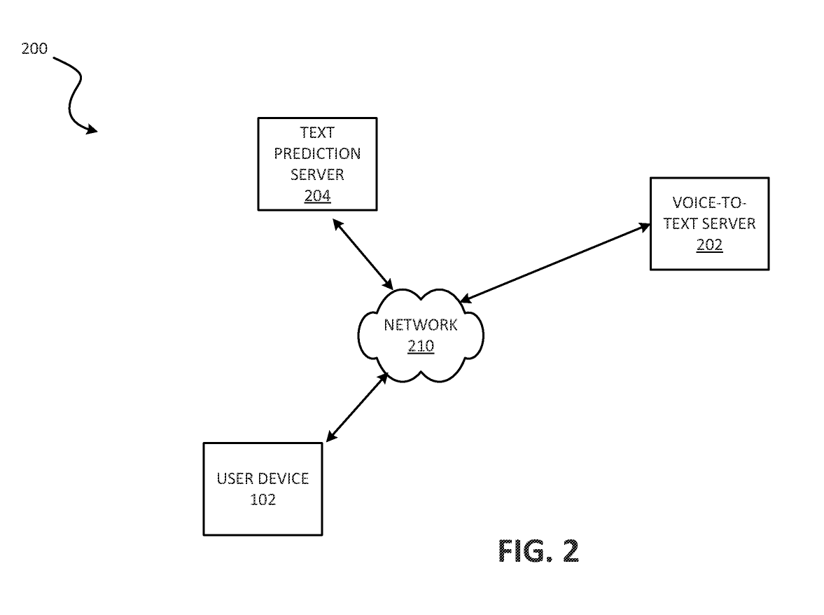

FIG. 2 illustrates an environment 200 that may be used according to one embodiment. Environment 200 includes user device 102, voice-to-text server 202 (V2T server 202), text prediction server 204, and a network 210. As discussed above, user device may include, for example, a mobile device such as a mobile phone or a tablet computer.

Network 210 may allow the devices in environment 200 (e.g., device 102, text prediction server 204, and V2T server 202) to communicate with each other. Network 210 may include one or more wired and/or wireless networks that may receive and transmit data, sound (e.g., voice), or video signals. Network 210 may include one or more BTSs (not shown) for transmitting or receiving wireless signals to/from mobile communication devices, such as user device 102, using wireless protocol (e.g., GSM, CDMA, WCDMA, GPRS, EDGE, etc). Network 210 may further include one or more packet switched networks, such as an Internet protocol (IP) based network, a local area network (LAN), a wide area network (WAN), a personal area network (PAN), a virtual private network (VPN), or another type of network that is capable of carrying data. Network 210 may also include one or more circuit-switched networks, such as a PSTN.

V2T server 202 may receive audio data (e.g., recorded voice and audio information) from user devices, such as user device 102. V2T server 202 may convert the audio data into text. In one embodiment, V2T server 202 converts audio data (e.g., audio data representing a spoken word) into a list of words predicted to represent the audio data. That is, if the audio data is of a user saying “when,” then the text may include the following words thought to represent the spoken word: wren, men, when, send, and blend.

Text prediction server 204 may receive keyed input (e.g., one or more typed or keyed letters) from user devices, such as user device 102. Text prediction server 204 may predict the word that the corresponding user is typing. For example, if the keyed input is “w”, then the list of predicted words may include: what, who , when, where, and wine. Text prediction server 204 may also predict the words based on other information, such as previous words typed, previous words used by a particular user, the frequency of words used by a particular user, and/or the frequency of words used in a particular language (e.g., English)

The exemplary configuration illustrated in FIG. 2 is provided for simplicity. In other embodiments, environment 200 may include more, fewer, or different devices. Environment 200 may also include thousands, if not hundreds of thousands, of user devices, such as devices 102. Moreover, one or more devices in environment 200 may perform one or more functions of any other device in environment 200.

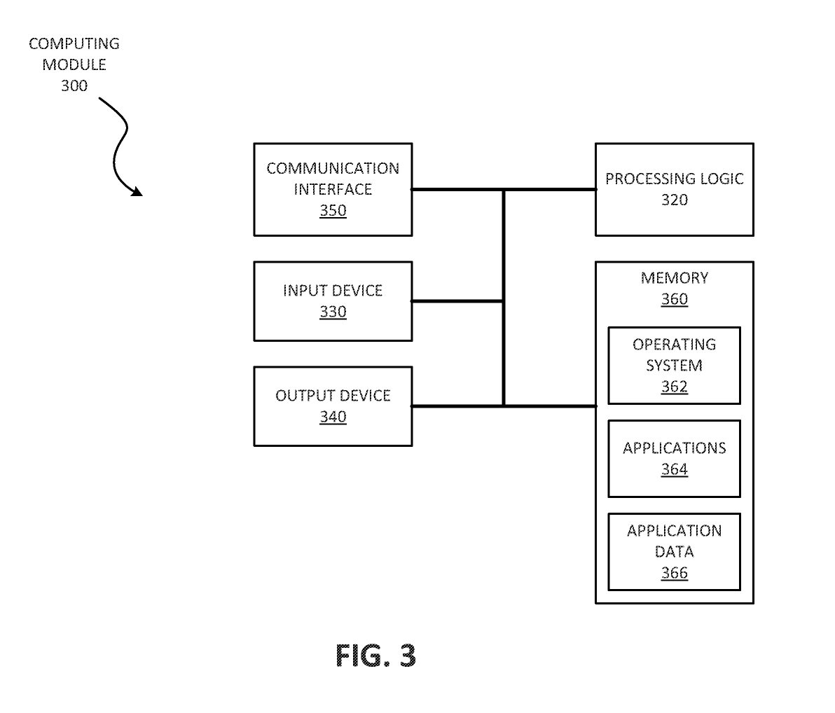

Devices in environment 200 may each include one or more computing modules. FIG. 3 is a block diagram of exemplary components of a computing module 300 according to one embodiment. Computing module 300 may include a bus 310, processing logic 320, an input device 330, an output device 340, a communication interface 350, and a memory 360. Computing module 300 may include other components (not shown) that aid in receiving, transmitting, and/or processing data. Moreover, other configurations of components in computing module 300 are possible.

Bus 310 includes a path that permits communication among the components of computing module 300. Processing logic 320 may include any type of processor or microprocessor (or families of processors or microprocessors) that interprets and executes instructions. In other embodiments, processing logic 320 may include an application-specific integrated circuit (ASIC), a field-programmable gate array (FPGA), etc.

Input device 330 may allow a user to input information into computing module 300. Input device 330 may include a keyboard (e.g., a physical keyboard or a soft keyboard such as keyboard 110), a mouse, a microphone (e.g., microphone 108), a remote control, an image and/or video capture device, a touch-screen display, etc. Some devices in environment 200, such as text prediction server 204 and/or V2T server 202, may be managed remotely and may not include input device 330. In other words, some devices may be “headless” and may not include a keyboard, for example.

Output device 340 may output information to the user. Output device 340 may include a display, a printer, a speaker, etc. For example, user device 102 may include display 106 (an output device), which may include a liquid-crystal display (LCD) for displaying content to the user. Headless devices, such as text prediction server 204 and/or V2T server 202 may be managed remotely and may not include output device 340.

Input device 330 and output device 340 may allow a user to activate and interact with a particular service or application, such as a keyboard with predictive text capabilities. Input device 330 and output device 340 may allow a user to receive and view options and select from the options. The options may allow the user to select various functions or services associated with applications executed by computing module 300.

Communication interface 350 may include a transceiver that enables computing module 300 to communicate with other devices or systems. Communication interface 350 may include a transmitter that converts baseband signals to radio frequency (RF) signals or a receiver that converts RF signals to baseband signals. Communication interface 350 may be coupled to an antenna for transmitting and receiving RF signals. Communication interface 350 may include a network interface card, e.g., Ethernet card, for wired communications or a wireless network interface (e.g., a WiFi) card for wireless communications. Communication interface 350 may also include, for example, a universal serial bus (USB) port for communications over a cable, a Bluetooth™ wireless interface, a radio-frequency identification (RFID) interface, a near-field communications (NFC) wireless interface, etc.

Memory 360 may store, among other things, information and instructions (e.g., applications 364 and operating system 362) and data (e.g., application data 366) for use by processing logic 320. Memory 360 may include a random access memory (RAM) or another type of dynamic storage device, a read-only memory (ROM) device or another type of static storage device, and/or some other type of magnetic or optical recording medium and its corresponding drive (e.g., a hard disk drive).

Operating system 362 may include software instructions for managing hardware and software resources of computing module 300. For example, operating system 362 may include Linux, BSD, Solaris, Windows, OS X, iOS, Android, an embedded operating system, etc. Applications 364 and application data 366 may provide network services or include applications, depending on the device in which the particular computing module 300 is found. For example, user device 102 may include a voice keyboard application to perform the functions described herein. As another example, V2T server 202 may include an application to generate text from audio files of recorded user voices.

Computing module 300 may perform the operations described herein in response to processing logic 320 executing software instructions stored in a non-transient computer-readable medium, such as memory 360. A computer-readable medium may include a physical or logical memory device. The software instructions may be read into memory 360 from another computer-readable medium or from another device via communication interface 350. The software instructions stored in memory 360 may cause processing logic 320 to perform processes that are described herein.

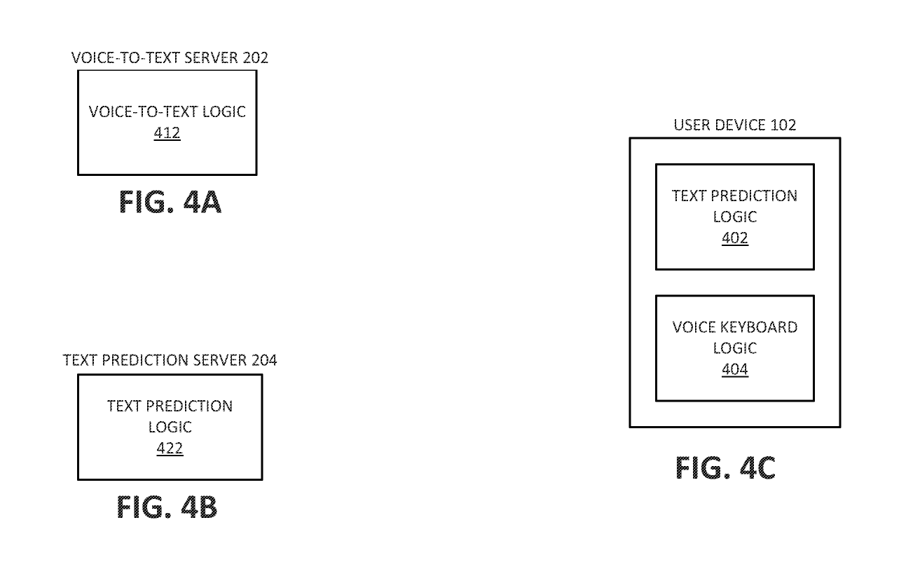

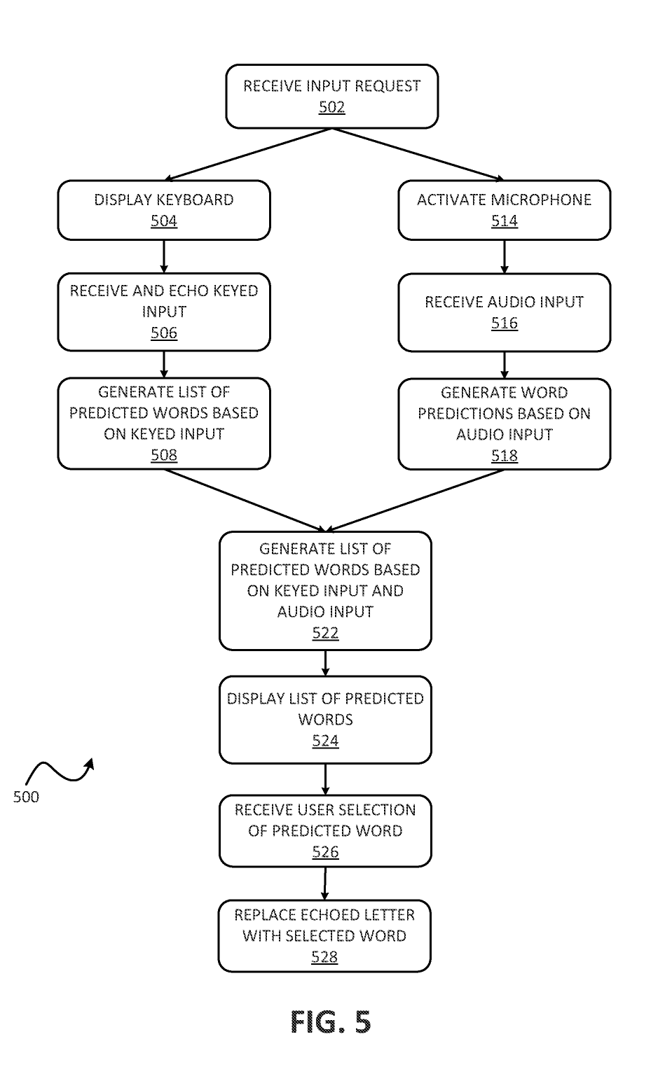

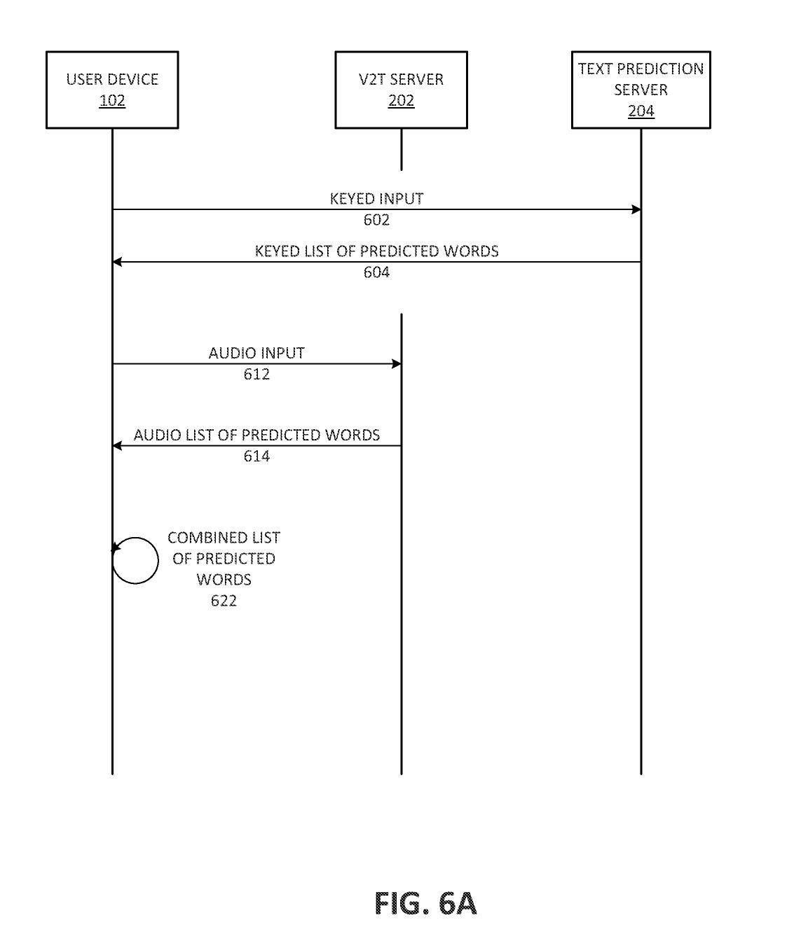

FIG. 4A is a bock diagram of the functional components of V2T server 202 of FIG. 2. V2T server 202 may include voice-to-text logic 412 (“V2T logic 412”). V2T logic 412 may receive audio data representing recordings of spoken language (e.g., English) including spoken words and generate text likely to correspond to the audio recordings. For example, if the audio recording is “When are you going to the party?”, V2T logic 412 may generate the text “When are you going to the party?” V2T logic 412 may generate the text based on the statistical likelihood of the text corresponding to the audio recording. In one embodiment, V2T logic 412 may generate a list of predicted words, where the list includes the text of words likely to correspond to the audio recording. For example, if the audio recording is of the user saying “when”, V2T logic 412 may predict that the user said one of the following words: wren, men, when, send, or blend.

FIG. 4B is a block diagram of the functional components of text prediction server 204 of FIG. 2. Text prediction server 204 may include text prediction logic 422. Text prediction logic 422 may receive keyed input from a user and may predict the word that the user is typing. For example, when the user types “w”, text prediction logic 422 may predict that the word being typed is: what, who, when, where, or wine. Text prediction logic 422 may base predictions on the frequency that the words appear in the English language, the frequency that the words are typed by the particular user, the words preceding the word being typed, etc. Text prediction logic 422 may also take into account mistyped words. For example, if the user keyed the letter “w”, text prediction logic 422 may make predictions based on the likelihood that the user intended to type the following letters: q, a, s, d, or e, for example (e.g., letters around the letter “w”).

FIG. 4C is a block diagram of the functional components of user device 102 of FIG. 1. User device 102 may include text prediction logic 402 and voice keyboard logic 404. Text prediction logic 402 may receive keyed input from the user and may predict the word that the user is typing. For example, when the user types “w”, text prediction logic 402 may predict that the word being typed is: what, who, when, where, or wine. Text prediction logic 402 may base predictions on the frequency that the words appear in the English language, the frequency that the words are typed by the particular user, the words preceding the typed word, etc. Text prediction logic 402 may also take into account mistyped words. For example, if the user keyed the letter “w”, text prediction logic 402 may make predictions based on the likelihood that the user intended to type the following letters: q, a, s, d, or e, for example (e.g., letters around the letter “w”). Text prediction logic 402 in user device 102 may render text prediction logic 422 and text prediction server 204 superfluous, in which case text prediction server 204 and text prediction logic 422 may be omitted. In one embodiment, text prediction logic 402 in user device 102 and text prediction logic 422 in server 204 may work in tandem, for example.

Voice keyboard logic 404 may provide word predictions based on both the characters the user is typing and what the user is saying. For example, the user may start typing the word “when” as the user says the word “when.” Voice keyboard logic 404 may predict what word the user is trying to input into user device 102 based on what the user has typed (so far) and what the user has said. Voice keyboard logic 404 may display these predicted words on display 106 as list 114 (see FIG. 1). Voice keyboard logic 404 may also receive a selection of one of the words in list 114 for display in echo field 112. Voice keyboard logic 404 may interact with text prediction logic 402 (in user device 102), V2T server 202, and/or text prediction server 204. For example, text prediction logic 402 and/or text prediction server 204 may generate a list of predicted words based on the keyed input, and V2T server 202 may generate a list of predicted words based on the audio input (e.g., the user speaking) In this case, voice keyboard logic 404 may generate a list of predicted words based on the keyed prediction list and the voice prediction list.

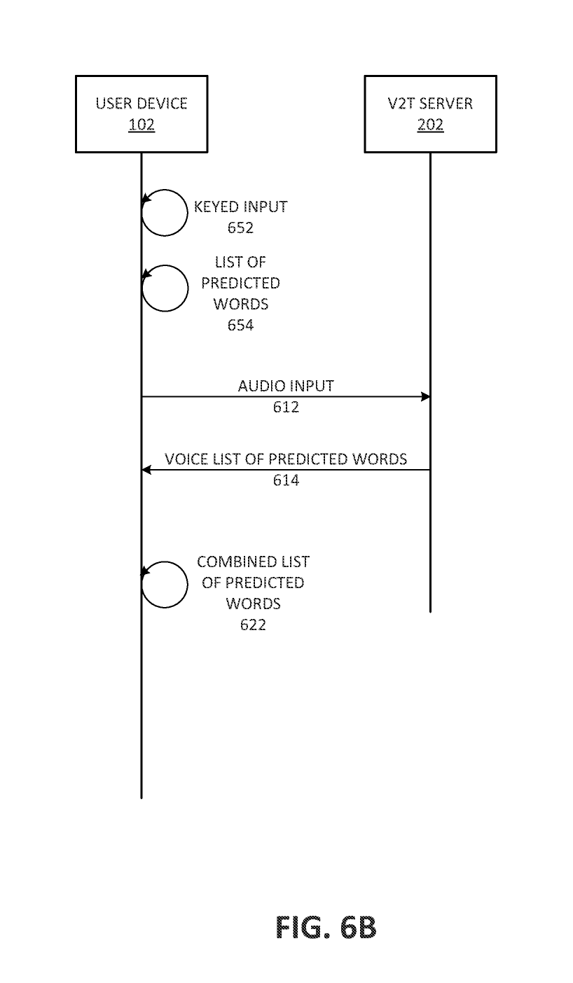

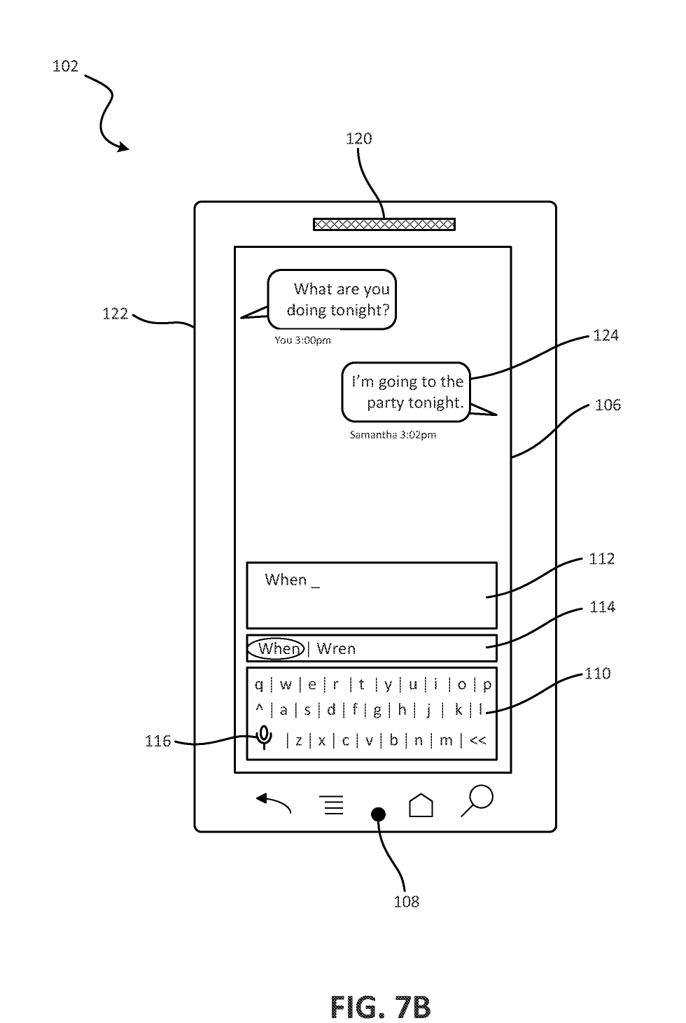

FIG. 5 is a flowchart for a process 500 implementing a voice keyboard in one embodiment. Process 500 may be performed by user device 102, V2T server 202, and/or text prediction server 204. Process 500 may begin when user device 102 receives a request for the input of information (block 502). For example, as shown in FIG. 1, the user of device 102 may wish to respond to text message 124 on display 106 and may do so by selecting, for example, echo field 112 by touching field 112 on display 106. In response, user device 102 may display keyboard 110 (block 504). The user may begin to type a message by pressing on a key displayed on keyboard 110 (block 506). For example, the user starts to type the message “When will you be at the party?” In this example, the user starts by pressing the “w” key (shown circled in FIGS. 1 and 7A) on keyboard 110. As shown in FIGS. 1 and 7A, a “w” is echoed to field 112 of display 106 (block 506). The keyed input may include more than one letter (e.g., “wh”), which may also be echoed to field 112.

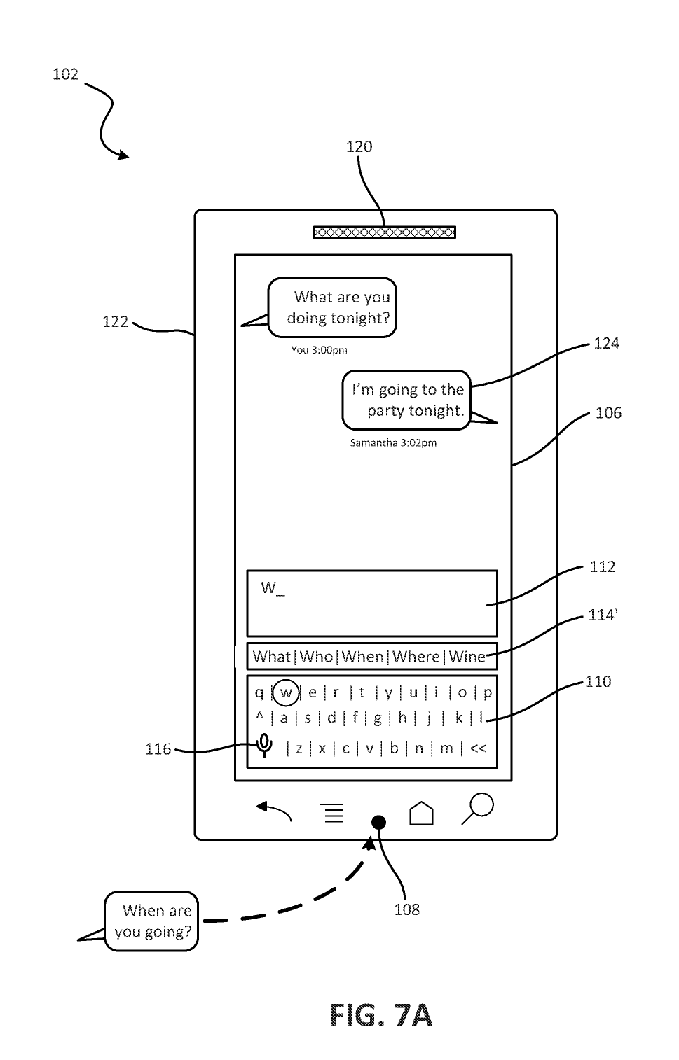

A predicted word list may be generated based on the keyed input (block 508) (e.g., a “keyed prediction list”). In one embodiment, as shown in FIG. 6A, user device 102 may transmit a message 602 (keyed input message 602) including the keyed input (e.g., “w” or “wh”) to text prediction server 204. Keyed input message 602 may include one or more letters to a word, for example, being typed by the user of user device 102. Text prediction server 204 receives keyed input message 602 and text prediction logic 422 generates a list of predicted words based on keyed input message 602 (block 508). Text prediction server 204 transmits a message 604 including the list of predicted words back to user device 102, which receives message 604. In the current example, the list of predicted words may include: what, who, when, where, and wine.

In another embodiment, user device 102 may generate the list of predicted words based on the keyed input (e.g., rather than text prediction server 204). Thus, text prediction logic 402 in user device 102 may generate the list of predicted words based on the keyed input. This embodiment is illustrated in FIG. 6B as keyed input message 652 and the list of predicted words message 654 being generated and retained in user device 102. Again, in the current example, the list of predicted words may include: what, who, when, where, and wine. Therefore, user device 102 may not necessarily transmit the keyed input (e.g., keyed input message 602) to text prediction server 204 or wait for the list of predicted words (e.g., message 604) to be received from text prediction server 204.

User device 102 may also activate microphone 108 (block 514). In one embodiment, user device 102 may activate microphone 108 at approximately the same time keyboard 110 is displayed. In another embodiment, user device 102 may not activate microphone 108 until a key press is detected (e.g., in block 506). By “activating” microphone 108, user device 102 begins to record audio (e.g., the user's voice) for the purpose of predicting the spoken and/or typed word. In the current example, the user of device 102 may say “when” as the user starts to type “when” into keyboard 110.

User device 102 may receive audio input (e.g., spoken words) for a period of time or continuously (block 516). Another list of predicted words may be generated based on the audio input (block 518) (e.g., “voice prediction list”). In one embodiment, as shown in FIG. 6A, user device 102 may transmit the audio input to V2T server 202 as audio input signal 612. V2T server 202 receives audio input message 612 and V2T logic 412 generates a list of predicted words based on the audio input. V2T server 202 then transmits the list of predicted words to user device 102 as message 614. In the current example, the list of predicted words based on the audio input may include: wren, men, when, send, and blend.

In another embodiment, user device 102 may generate the predicted word list based on the audio input (e.g., rather than V2T server 202). Thus, user device 102 may include voice-to-text logic (not shown) that may generate the list of predicted words based on the audio input. Again, in the current example, the list of predicted words based on the audio input may include: wren, men, when, send, and blend. In this embodiment, user device 102 may not necessarily transmit the audio input (e.g., signal 612) to V2T server 202 or wait for the list of predicted words to be received from V2T server 202.

A combined predicted word list may be generated (block 522) based on both the audio input and the keyed input (e.g., a “combined prediction list”). In one embodiment, user device 102 (e.g., voice keyboard logic 404) generates the combined prediction list from the keyed prediction list and the voice prediction list. In one implementation, the keyed prediction list may be generated before the voice prediction list. In this case, the combined prediction list may be based on the keyed prediction list until the voice prediction list is received from V2T server 202. For example, assume that the keyed prediction list includes: what, who, when, where, and wine. Also assume that the voice prediction list has not yet been received from V2T server 202. In this case, the combined prediction list may include: what, who, when, where, and wine (e.g., the same list as the keyed prediction list). This example is illustrated in FIG. 7A in which prediction list 114′ displayed (block 526) on display 106 includes: what, who, when, where, and wine. This combined prediction list may be updated when the keyed prediction list is received or generated. For example, as shown in FIG. 7B, list 114′ is replaced with list 114, which includes: when and wren.

In one embodiment, the combined list may be the intersection of the voice prediction list and the keyed prediction list. In another embodiment, the combined list may be based on the confidence levels associated with each predicted word. For example, assume that the keyed prediction list includes: what, who, when, where, and wine. Also, assume that the voice prediction list includes: wren, men, when, send, and blend. In this example, the words “when” and “wren” may have high confidence levels as compared to the other words in the two lists. Thus, the combined prediction list may include: when and wren (e.g., the words in common between voice prediction list and keyed prediction list). This example is illustrated in FIG. 7B, in which prediction list 114 displayed (block 526) on display 106 includes: when and wren.

In one implementation, the voice prediction list may be generated before the keyed prediction list. In this case, the combined prediction list may be based on the voice prediction list until the keyed prediction list is generated or received. For example, assume that the voice prediction list includes: wren, men, when, send, and blend. Also assume that the text prediction list has not yet been received or generated. In this case, the combined prediction list may include: wren, men, when, send, and blend (e.g., the same list as the voice prediction list).

As the user types a word (or before if a list of predicted words is generated based on the audio input before the user starts to type), user device 102 may receive a selection from the user of one of the words in the prediction list (block 526). For example, in the current example, the user may select “when” from list 114′ (FIG. 7A) or from list 114 (FIG. 7B) rather than continuing to type “hen” following the “w.” In this case, the selected word may be echoed to display 106 in echo field 112 (block 528) to replace the previously typed echoed characters (e.g., “w”). As shown in FIG. 7B, the user has selected “when” from list 114 and the word “when” has been echoed to field 112.

The keyed input may indicate mistyped characters indicative of a word, such as characters that are around the key “w” (e.g., q, a, s, d, or e) on keyboard 110 to indicate the word “when.” In this case, text prediction logic 402, text prediction logic 422 and/or V2T logic 412 may still be able to predict successfully the intended word.

In the example above, the combined list is generated from the keyed list and the audio list. In another embodiment, the combined list may be generated without generating the keyed list or the audio list. For example, the keyed input may be used to narrow the list of predicted words based on the audio input. That is, if the list of predicted words based on the audio input is generated based on statistical likelihoods, the keyed input may inform the selection of the words for the list of predicted words based on the audio. That is, the keyed input may be used in combination with the audio input to directly generate the combined list.

Certain features described above may be implemented as “logic” or a “unit” that performs one or more functions. This logic or unit may include hardware, such as one or more processors, microprocessors, application specific integrated circuits, or field programmable gate arrays, software, or a combination of hardware and software.

No element, act, or instruction used in the description of the present application should be construed as critical or essential to the invention unless explicitly described as such. Also, as used herein, the article “a” is intended to include one or more items. Further, the phrase “based on” is intended to mean “based, at least in part, on” unless explicitly stated otherwise.

In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A computer-implemented method comprising:
receiving a keyed input from a user in a user device, wherein the keyed input indicates a letter of a word;
receiving an audio input from the user in the user device, wherein the audio input indicates the word;
generating a first list of predicted words based on the audio input and the keyed input from the user; and
displaying the first list of predicted words to the user on a display.

2. The computer-implemented method of claim 1, further comprising:
generating a second list of predicted words based on the keyed input and not the audio input; and
generating a third list of predicted words based on the audio input and not the keyed input,
wherein generating the first list of predicted words includes generating the first list of predicted words based on the second list of predicted words and the third list of predicted words.

3. The computer-implemented method of claim 1, further comprising:
echoing the keyed input to a field on the display;
receiving a selection of one of the words in the first list of predicted words; and
displaying the selected one of the words in the field on the display, wherein the selected one of the words replaces the echoed keyed input.

4. The computer-implemented method of claim 2, further comprising:
receiving another keyed input from the user, wherein the other keyed input indicates another letter of the word;
updating the second list of predicted words based on the other keyed input;
updating the first list of predicted words based on the updated second list of predicted words and the third list of predicted words.

5. The computer-implemented method of claim 2, further comprising:
transmitting the audio input through a network to speech-to-text logic to recognize the audio input and to generate the second list of predicted words based on the audio input; and
receiving the second list of predicted words in the user device from the speech-to-text logic through the network.

6. The computer-implemented method of claim 2, further comprising:
transmitting the keyed input through the network to text prediction logic to generate the first list of predicted words; and
receiving the first list of predicted words in the user device from the text prediction logic through the network.

7. The computer-implemented method of claim 2, further comprising:
displaying an icon indicating to the user that the displayed third list of predicted words is based on the audio input and the keyed input.

8. A system comprising:
a user device comprising:
a keyboard to receive a keyed input from a user, wherein the keyed input indicates a letter of a word;
a microphone to receive an audio input from the user in the user device, wherein the audio input indicates the word; and
a display to display a first list of predicted words to the user, wherein the first list of predicted words is generated based on the audio input and the keyed input from the user.

9. The system of claim 8, further comprising:
one or more processors to:
generate a second list of predicted words based on the keyed input and not the audio input;
generate a third list of predicted words based on the audio input and not the keyed input;
generate the first list of predicted words based on the second list of predicted words and the second list of predicted words.

10. The system of claim 8,
wherein the display is configured to echo the keyed input to a field on the display,
wherein the keyboard is configured to receive a selection of one of the words in the first list of predicted words displayed, and
wherein the display is configured to display the selected one of the words in the field on the display, wherein the selected one of the words replaces the echoed keyed input.

11. The system of claim 9, wherein the keyboard is configured to receive another keyed input from the user, wherein the other keyed input indicates another letter of the word;
wherein the processor is configured to update the second list of predicted words based on the other keyed input;
wherein the processor is configured to update the first list of predicted words based on the updated second list of predicted words and the third list of predicted words.

12. The system of claim 9, wherein the user device further comprises:
a transmitter to transmit the audio input through a network to speech-to-text logic to recognize the audio input and to generate the second list of predicted words based on the audio input; and
a receiver to receive the second list of predicted words in the user device from the speech-to-text logic through the network.

13. The system of claim 9, further comprising:
a transmitter to transmit the keyed input through the network to text prediction logic to generate the first list of predicted words; and
a receiver to receive the first list of predicted words in the user device from the text prediction logic through the network.

14. The system of claim 8, wherein the display is configured to display an icon indicating to the user that the displayed first list of predicted words is based on the audio input and the keyed input.

15. A computer-readable medium including instructions that, when executed by a processor, cause the processor to perform a method, the instructions comprising:
instructions to receive a keyed input from a user in a user device, wherein the keyed input indicates a letter of a word;
instructions to receive an audio input from the user in the user device, wherein the audio input indicates the word; and
instructions to display a first list of predicted words on a display of the user device, wherein the first list of predicted words is based on the audio input and the keyed input from the user.

16. The computer-readable medium of claim 15, further comprising:
instructions to generate a second list of predicted words based on the keyed input and not the audio input;
instructions to generate a third list of predicted words based on the audio input and not the keyed input, wherein the instructions to generate the first list of words includes instructions to generate the first list of predicted words based on the second list of words and the third list of words.

17. The computer-readable medium of claim 15, further comprising:
instructions to echo the keyed input to a field on the display;
instructions to receive a selection of one of the words in the first list of predicted words displayed; and
instructions to display the selected one of the words in the field on the display, wherein the selected one of the words replaces the echoed keyed input.

18. The computer-readable medium of claim 16, further comprising:
instructions to receive another keyed input from the user, wherein the other keyed input indicates another letter of the word;
instructions to update the second list of predicted words based on the other keyed input; and
instructions to update the first list of predicted words based on the updated second list of predicted words and the third list of predicted words.

19. The computer-readable medium of claim 16, further comprising:
instructions to transmit the audio input through a network to speech-to-text logic to recognize the audio input and to generate the second list of predicted words based on the audio input; and
instructions to receive the second list of predicted words in the user device from the speech-to-text logic through the network;
instructions to transmit the keyed input through the network to text prediction logic to generate the first list of predicted words; and
instructions to receive the first list of predicted words in the user device from the text prediction logic through the network.

20. The computer-readable medium of claim 15, further comprising:
instructions to display an icon indicating to the user that the displayed third list of predicted words is based on the audio input and the keyed input.
